(19) United States
(12) Patent Application Publication
(10) Pub. No.: US 2005/0259521 A1
(43) Pub. Date: Nov. 24, 2005

(54) Locking hinge device for a watchcase

(76) Inventor: Kai Cheung Ho, Kowloon (HK)

Correspondence Address: J.C. Patents, Suite 250, 4 Venture, Irvine, CA, 92618, US

(21) Appl. No.: 11/089,416

(22) Filed: Mar. 23, 2005

(30) Foreign Application Priority Data
May 20, 2004 (CN) 2004200499952

(51) Int. Cl. G04B 37/00

(52) U.S. Cl. 368/281

(57) ABSTRACT

A locking hinge device for a watchcase comprises an upper case and a lower case, the upper case having at least one lug projectively formed at one side and provided with a through hole therein, and the lower case having at least one lug projectively formed at a position corresponding to the lug of the upper case and provided with a through hole therein, the diameter of which is same as or similar to that of the through hole of the upper case and the axis of which is coincident with that of the through hole of the upper case, wherein a hinge shaft is disposed through the holes of the upper and lower cases, about which the upper case can be pivoted and held in any position. The device of the present invention is convenient and safe for use.

### CROSS-REFERENCE TO RELATED APPLICATION

This application claims the priority benefit of Chinese Utility Model Application No. 2004200499952 filed on May 20, 2004, the content of which is hereby incorporated in its entirety herein by reference.

### FIELD OF THE INVENTION

The present invention relates to an articulated shaft, particularly to a locking hinge device for a watchcase.

### BACKGROUND OF THE INVENTION

As the developments of technology and economy, watches are designed to have more and more functions. For example, a thermometer or a compass could be combined with a watch. Such multifunctional watch often has two layers, i.e. an upper case and a lower case, wherein the upper case is a watchcase in which a movement is disposed to be used as an ordinary watch, the lower case comprises a compass or a thermometer therein to perform a further function other than a timepiece. The upper and lower cases are articulated by a pivot shaft on one end and opened and closed by a clasp on the other end. The lower case is further pivotably connected with the watch chain.

Although a watch with the above-mentioned construction can perform multiple functions, the upper case must be held in position by hand after being opened with respect to the lower case, otherwise it will fall down and contact with the lower case by gravity since they are attached only by a pivot shaft. The sudden falling of the upper case may accidentally damage the compass or thermometer mounted in the lower case. In addition, it is inconvenient to hold the upper case in position when using the watch.

To solve problems in the prior art, relying on rich experiences in the related industry, the present inventor developed a novel construction for a hinge shaft, which can hold the upper case in any position without using hand to prevent it from accidentally falling down.

### SUMMARY OF THE INVENTION

An object of the present invention is to provide a locking hinge device solving the existing problems in the multifunctional watch that the upper case cannot be held in position and often damages the components in the lower case since they are connected by a pivot shaft.

To achieve the object, the present invention provides a locking hinge device for a watchcase, comprising an upper case and a lower case, the upper case having at least one lug projectively formed on one side and provided with a through hole therein, and the lower case having at least one lug projectively formed at a position corresponding to the lug of the upper case and provided with a through hole therein, the diameter of which is same as or similar to that of the through hole of the upper case and the axis of which is coincident with that of the through hole of the upper case, wherein a hinge shaft is disposed through the holes of the upper and lower cases, about which the upper case can be pivoted and held in any position.

The locking hinge shaft comprises a locking gear set including two gears engaging with each other, wherein one gear is attached with the lug of upper case by a connecting member, and the other gear is attached with the lug of the lower case by a further connecting member.

The locking hinge shaft comprises two or more locking gear sets, each including two gears engaging with each other, wherein one gear is attached with the lug of the upper case by a connecting member, and the other is attached with the lug of the lower case by a further connecting member.

An elastic element is disposed between two adjacent locking gear sets.

Two adjacent gears of the adjacent locking gear sets are coupled together or formed integrally by a gear with teeth on both ends.

The locking gear has teeth on its end surface, a fastening hole on its side edge for attaching with the connecting member.

The hinge shaft further includes plugs for sealing into the through holes in the upper or lower case.

The fastening hole is a thread hole.

In the locking hinge device for a watchcase according to the present invention, the open angle of the upper case can be controlled by two gears engaging with each other and the upper case can be held in position. It is convenient and safe to use.

### BRIEF DESCRIPTION OF THE DRAWING

FIG. 1 is a view illustrating a watch with a hinge device according to an embodiment of the present invention;

FIG. 2 is a side view of the upper case according to an embodiment of the present invention;

FIG. 3 is a partial view seen from direction A illustrating the upper case of FIG. 2;

FIG. 4 is a side view of the lower case according to an embodiment of the present invention;

FIG. 5 is a top view of the lower case according to an embodiment of the present invention;

FIG. 6 is a section view along line B-B in FIG. 1;

FIGS. 7A-7C are front, top and section views respectively of a locking gear according to an embodiment of the present inventor;

FIGS. 8A-8C are front, top and section views respectively of a locking gear according to another embodiment of the present invention;

FIG. 9 is a side view of a connecting member according to an embodiment of the present invention;

FIG. 10 is a section view taken along line B-B in FIG. 1 according to another embodiment of the present invention;

FIG. 11 is a section view taken along line B-B in FIG. 1 according to a further embodiment of the present invention.

### DETAILED DESCRIPTION OF THE PREFERRED EMBODIMENT

### Embodiment 1

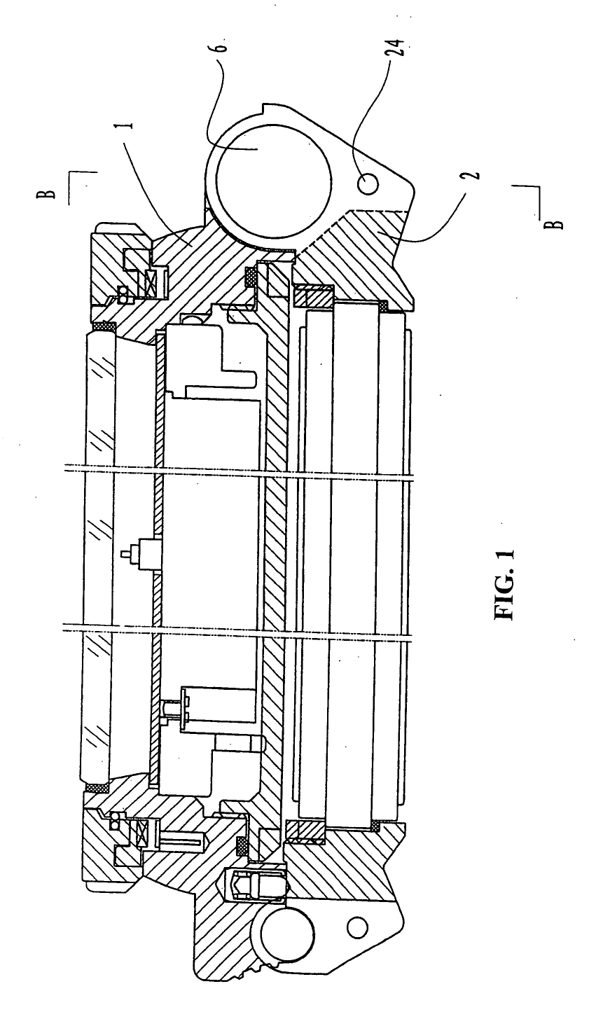

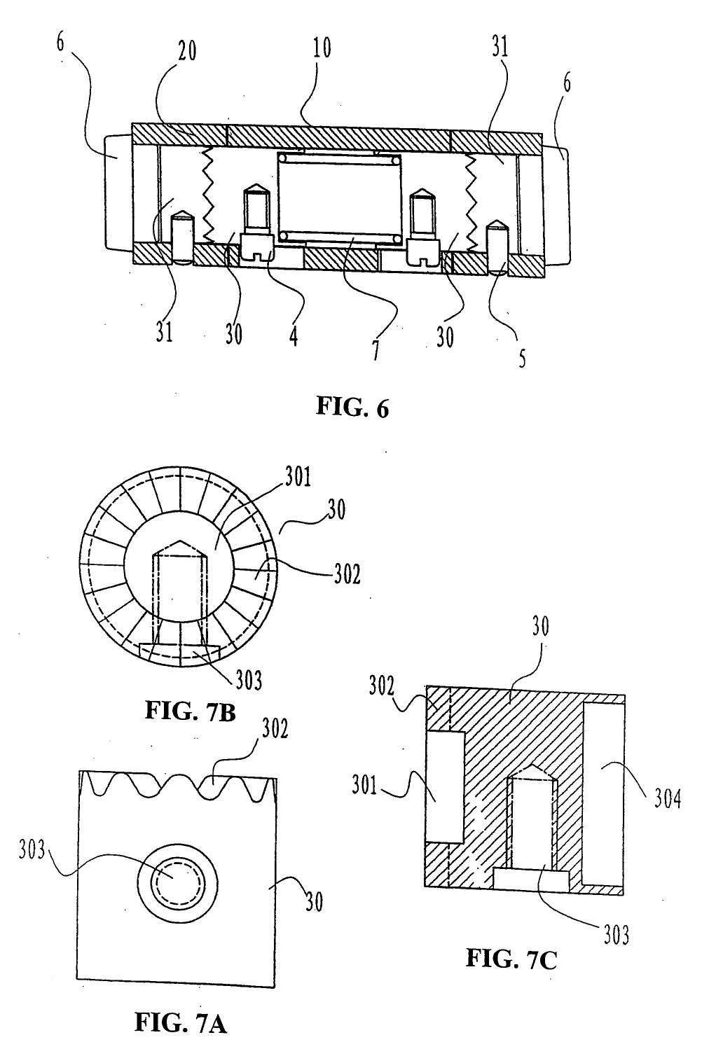

As shown in FIGS. 1 and 6, the locking hinge device for a watchcase of a watch includes an upper case 1, a lower case 2, two locking gear sets, connecting members 4 and 5, plugs 6 and an elastic element 7.

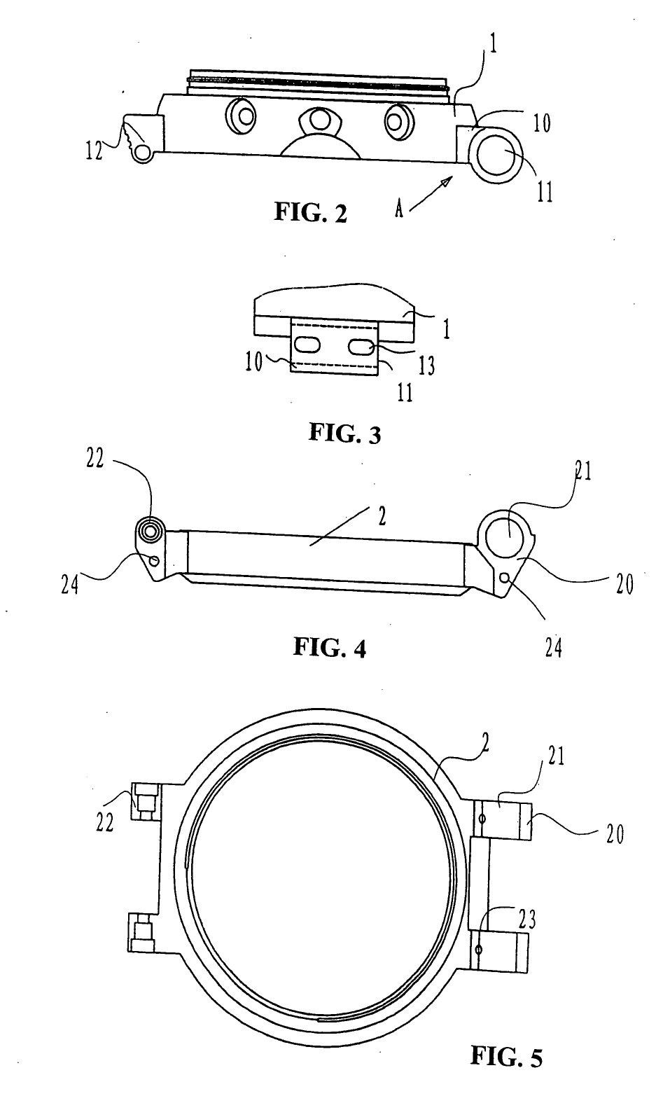

As shown in FIGS. 2 and 3, the upper case 1 is provided with a lug 10 on one side and a locking clasp 11 on the opposite side. The contour of the upper case 1 may be circular or rectangular to be consistent with that of the current multifunctional watchcase. A through hole 12 is disposed in the lug 10, and two holes 13 are provided though the side wall of the lugs, the axes of which are vertical to that of the through hole 12. As shown in FIG. 3, the cross section of the through hole 13 is oval.

As shown in FIGS. 4 and 5, the lower case 2 is the same as the upper case 1 in shape and they can engage with each other and form a cover for each other. There are two lugs disposed on a side of the lower case 2 corresponding to the side of the upper case 1 with the lug 10, and a fastening clasp 21 disposed on the other side to fit with the locking clasp 11, wherein the space between two lugs 20 just accommodates the lug 10 of the upper case 1 and allow the upper case 1 to pivot freely.

Two through hole 22 are provided in the plugs 20 respectively with a same axis. When the upper case 1 engages with the lower case 2, the through hole 12 of the lug 10 is positioned on the same axis as the through hole 22 of the lug 20 and the locking clasp 11 fits with the fastening clasp 12 to attach two cases together. (The construction of the locking clasp 11 and the fastening clasp 12 are same as those used in the conventional multifunctional watch and the detailed description is omitted. Their relative position could be changed if desired.) A through hole 23 with a circular cross section is disposed in each of the lugs 20, as shown in FIG. 5. In addition, a through hole 24 is disposed in each side of the lower case 2 near the lugs 20 or the fastening clasp 21 respectively, by which the lower case 2 can be connected with the watch chain.

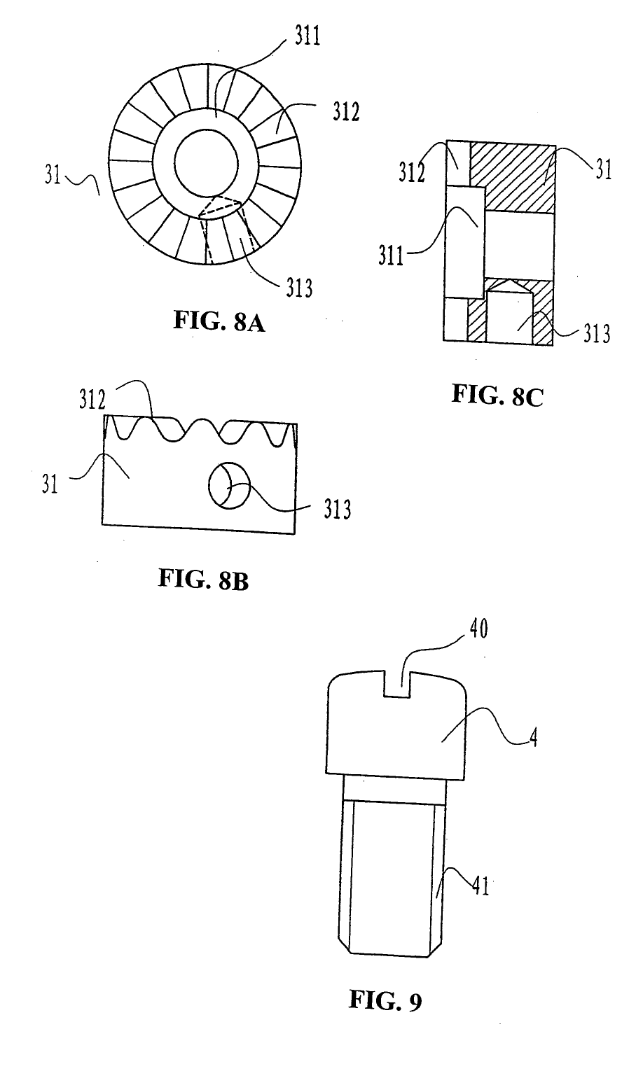

As shown in FIG. 6, the locking gear set comprises locking gears 30, 31 engaging with each other. As shown in FIGS. 7A to 7C, the locking gear 30 has a short cylindrical body, one end of which has a plan surface or is provided with a groove 304 for a spring 7 and the other end of which is provided with a blind hole 301 and a plurality of teeth 302 surrounding the hole 301. There is a thread hole 303 provided on the circumferential surface of the cylindrical body. As shown in FIGS. 8A to 8C, the locking gear 31 is similar to the locking gear 30 and also has a short cylindrical body, one end of which has a plan surface, the other end of which is provided with a blind hole 311 and a plurality of teeth 312 surrounding the hole 311 and the circumferential surface of which is provided with a fastening hole 313.

As shown in FIG. 9, the connecting member 4 for connecting the locking gear 30 with the upper case 1 is a bolt, one end of which is provided with a “-” shape groove 40 for tools and the other end of which is provided with outer threads 41 for engaging with the thread hole 303. The connecting member 5 for connecting the locking gear 30 with the lower case is an insert which tightly fits with the fastening hole 313 and the through hole 23.

The operation for assembling the locking hinge device of the present application to a watchcase is as follows:

First, an elastic element 7, which may be a compression spring, is provided in the through hole 11 of the lug 10 in the upper case 1. Then, the lug 10 is mounted between the lugs 20 of the lower case 2 to position the axles of the through holes 11 and 12 on one line. The gears of the locking gear set 3 are inserted from both ends of the through hole 12 respectively, and fixed by the connecting members 4 and 5 such that the gear 30 is attached with the upper case 1 and the gear 31 is attached with the lower case 2. Finally, a plug 6 is inserted into each end of the through hole 21 to seal it. Thus, a hinge shaft comprising the locking gears 30, 31 and the elastic element 7 is formed, through which the upper case 1 can pivot relative to the lower case 2, and can be held in position at different angles when pivoting by means of the engagement of teeth 302 and 312 of the gears 30 and 31.

### Embodiment 2

As shown in FIG. 11, the locking hinge device of the present embodiment is similar to embodiment 1 and the difference is that there is only one locking gear set, wherein a locking gear drives the upper case 1 to rotate by engaging with the thread in the connecting member 4, the other locking gear is fixed to the lower case 2 by the connecting member (pin) 5 and the ends of the gears are sealed by plugs 6. Thus, the object that the upper case 1 can pivot and be held in position at different angle is realized by only one locking gear set.

### Embodiment 3

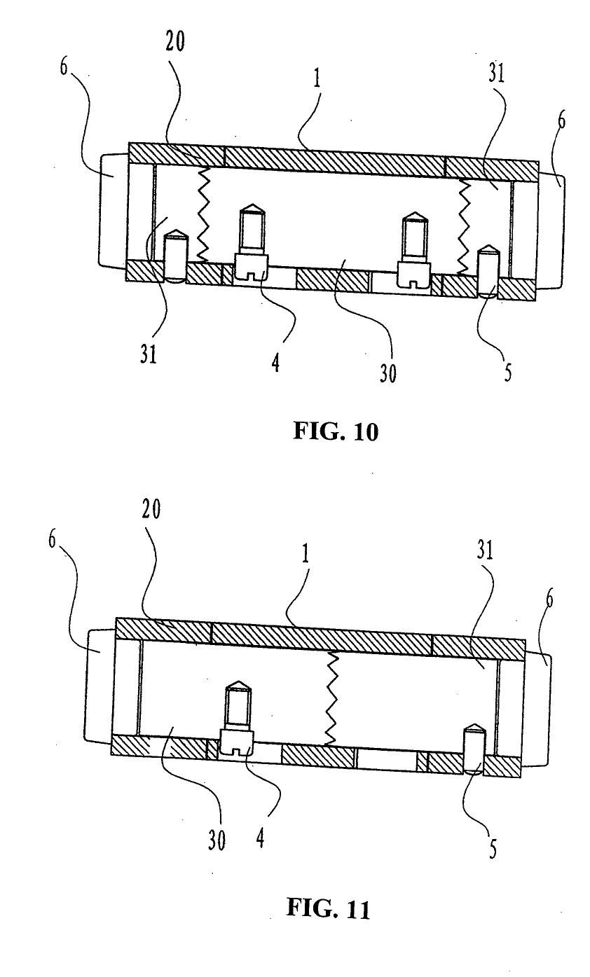

As shown in FIG. 10, the locking hinge device of the present embodiment is similar to embodiment 1 and the difference is that there is only one gear provided with teeth 302 on both ends. Thus, the object of the present invention is realized.

In summary, it is safe and convenient to use the locking hinge device of the present invention. However, while particular embodiments of the present invention have been illustrated and described, it would be obvious to those skilled in the art that various other charges and modification can be made without departing from the spirit and scope of the invention. It is therefore intended to cover in the appended claims all such changes and modification that are within the scope of this invention.

1. A locking hinge device for a watchcase, comprising an upper case and a lower case, wherein the upper case has at least one lug projectively formed on one side and provided with a through hole therein, and the lower case has at least one lug projectively formed at a position corresponding to the lug of the upper case and provided with a through hole therein, the diameter of which is same as or similar to that of the through hole of the upper case and the axis of which is coincident with that of the through hole of the upper case, characterized in that a hinge shaft is disposed through the holes of the upper and lower cases, about which the upper case can be pivoted and held in any position.

2. A locking hinge device for a watchcase as claimed in claim 1, characterized in that the locking hinge shaft comprises a locking gear set including two gears engaging with each other, wherein one gear is attached with the lug of upper case by a connecting member, and the other gear is attached with the lug of the lower case by a connecting member.

3. A locking hinge device for a watchcase as claimed in claim 1, characterized in that the locking hinge shaft comprises two or more locking gear sets, each including two gears engaging with each other, wherein one gear is attached with the lug of the upper case by a connecting member, and the other is attached with the lug of the lower case by a connecting member.

4. A locking hinge device for a watchcase as claimed in claim 3, characterized in that an elastic element is disposed between two adjacent locking gear sets.

5. A locking hinge device for a watchcase as claimed in claim 3, characterized in that two adjacent gears of the adjacent locking gear sets are coupled together or formed integrally by a gear with teeth on both ends.

6. A locking hinge device for a watchcase as claimed in claim 2, characterized in the locking gear has teeth on its end surface, a fastening hole on its side edge for attaching with the connecting member.

7. A locking hinge device for a watchcase as claimed in claim 2, characterized in that the hinge shaft further includes plugs for sealing into the through holes in the upper or lower case.

8. A locking hinge device for a watchcase as claimed in claim 6, characterized in that the fastening hole is a thread hole.

9. A locking hinge device for a watchcase as claimed in claim 3, characterized in the locking gear has teeth on its end surface, a fastening hole on its side edge for attaching with the connecting member.

10. A locking hinge device for a watchcase as claimed in claim 4, characterized in the locking gear has teeth on its end surface, a fastening hole on its side edge for attaching with the connecting member.

11. A locking hinge device for a watchcase as claimed in claim 3, characterized in that the hinge shaft further includes plugs for sealing into the through holes in the upper or lower case.

12. A locking hinge device for a watchcase as claimed in claim 4, characterized in that the hinge shaft further includes plugs for sealing into the through holes in the upper or lower case.

13. A locking hinge device for a watchcase as claimed in claim 5, characterized in that the hinge shaft further includes plugs for sealing into the through holes in the upper or lower case.

14. A locking hinge device for a watchcase as claimed in claim 9, characterized in that the fastening hole is a thread hole.

15. A locking hinge device for a watchcase as claimed in claim 10, characterized in that the fastening hole is a thread hole.
